(19) United States
(12) Patent Application Publication
(10) Pub. No.: US 2026/0212233 A1
(43) Pub. Date: Jul. 23, 2026

(54) SOLUTION DECOMPOSITION

(71) Applicant: NEC Laboratories America, Inc., Princeton, NJ (US)

(72) Inventors: Wei Cheng, Princeton Junction, NJ (US); Jonathan Li, Troy, NY (US); Haifeng Chen, West Windsor, NJ (US)

(21) Appl. No.: 19/453,628

(22) Filed: Jan. 20, 2026

Related U.S. Application Data
(60) Provisional application No. 63/747,491, filed on Jan. 21, 2025.

(51) Int. Cl. G06N 5/045; G06F 40/40

(52) U.S. Cl. CPC G06N 5/045; G06F 40/40

(57) ABSTRACT

According to an aspect of the present invention, a system method is provided for solution decomposition, the system and method comprising in response to a query, decomposing a solution using a recursive subprocess including generating complete solutions using a policy until there are enough complete solutions to determine a reward model, selecting at least one target step of the complete solutions based on the reward model, partitioning the at least one target step into at least two segments based on a predefined partition fraction, wherein for each segment, a priority metric is estimated, wherein the at least one target step is a first step or a segment of a previously partitioned step, appending the partitioned segment with a lower priority metric, determining whether an end condition has been met, and ending the recursive subprocess if the end condition is met; and outputting a decomposition.

### RELATED APPLICATION INFORMATION

This application claims priority to U.S. Provisional Patent Application No. 63/747,491, filed on Jan. 21, 2025, incorporated herein by reference in its entirety.

### BACKGROUND

### Technical Field

The present invention relates to solution decomposition and more particularly solution decomposition by partitioning the difficult tasks.

### Description of the Related Art

Inference scaling methods often involve breaking a solution into smaller parts and systematically. Recent attempts have shown the difficulty of applying search and inference scaling techniques when taking token level steps. Breaking the problem down manually or using domain specific heuristics presents significant human costs and is not very practical. Moreover, it is difficult for humans to understand what steps might be important for a large language model (LLM). LLMs often find steps such as single words like ‘therefore’ and ‘which’ important, which may be counterintuitive to humans but make great sense to LLMs trained autoregressively.

Furthermore, resources during inference scaling are often wasted on simple tasks and thus there is less utilization of computing resources on more difficult tasks. Thus, there is a need to decompose solutions during inference scaling that allocates resources more efficiently.

### SUMMARY

According to an embodiment of the present invention, a method is provided for solution decomposition, the method comprising in response to a query, decomposing a solution using a recursive subprocess including prompting a large language model to generate complete solutions using a policy until there are enough complete solutions to determine a reward model, selecting at least one target step of the complete solutions based on the reward model, partitioning the at least one target step into at least two segments based on a predefined partition fraction, wherein for each segment, a priority metric is estimated, wherein the at least one target step is a first step or a segment of a previously partitioned step, appending the partitioned segment with a lower priority metric, determining whether an end condition has been met, and ending the recursive subprocess if the end condition is met; and outputting a decomposition.

According to another embodiment of the present invention, a system is provided for solution decomposition, the system, comprising a memory device, one or more processor devices operatively coupled with the memory device to perform operations, the operations including a recursive subprocess including in response to a query, decompose a solution prompt a large language model to generate complete solutions using a policy until there are enough complete solutions to determine a reward model, select at least one target step of the complete solutions based on the reward model, partition the at least one target step into at least two segments based on a predefined partition fraction, wherein for each segment, a priority metric is estimated, wherein the at least one target step is a first step or a segment of a previously partitioned step, append the partitioned segment with a lower priority metric, determine whether an end condition has been met, and end the recursive subprocess if the end condition is met, and output a decomposition.

According to another embodiment of the present invention, a non-transitory computer program product is provided for solution decomposition, the non-transitory computer program product comprising a computer-readable storage medium including a program code, wherein the program code when executed on a computer causes the computer to perform in response to a query, decompose a solution a recursive subprocess including prompt a large language model to generate complete solutions using a policy until there are enough complete solutions to determine a reward model, select at least one target step of the complete solutions based on the reward model, partition the at least one target step into at least two segments based on a predefined partition fraction, wherein for each segment, a priority metric is estimated, wherein the at least one target step is a first step or a segment of a previously partitioned step, append the partitioned segment with a lower priority metric, determine whether an end condition has been met, and end the recursive subprocess if the end condition is met; and output a decomposition.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for solution decomposition, in accordance with an embodiment of the present invention;

FIG. 2 is an illustrative example of solution decomposition, in accordance with an embodiment of the present invention;

FIG. 3 is an illustrative example of a practical application of solution decomposition, in accordance with an embodiment of the present invention;

FIG. 4 is a block/flow diagram illustrating a system for solution decomposition, in accordance with an embodiment of the present invention;

FIG. 5 is a flow diagram illustrating a system/method for solution decomposition, in accordance with an embodiment of the present invention;

FIG. 6 and FIG. 7 show a pseudocode program for solution decomposition, in accordance with an embodiment of the present invention.

### DETAILED DESCRIPTION OF PREFERRED EMBODIMENTS

In accordance with embodiments of the present invention, systems and methods are provided to/for solution decomposition.

Embodiments of the present invention relate to decomposing solutions. Embodiments first generate potential samples by querying a large language model (LLM). Then, using a reward model, a best step is selected out of the samples. Then that best step is partitioned into at least two segments. For each segment, a priority metric value can be assigned to determine which segment is the most difficult to compute. For example, a lower priority metric can inversely indicate a greater difficulty. These priority metrics value assigned to the segments are estimated through rollouts of the best step using the same policy. Then the process repeats itself with the best step being the segment that is determined to be the most difficult by the priority metric.

The advantage of the embodiments is that there is a focus on using a limited computational budget on difficult tasks as opposed to wasting the budget on simple tasks. Thus, an advantage of the embodiments is a more efficient allocation of computational resources.

Practical application of the present embodiments of the present invention can include an artificial intelligence (AI) agent in a first responder role. If an AI agent is processing phone calls in an emergency responder role, the embodiments will result in a better response to the phone call despite a limited resource pool. For example, embodiments of the present invention will focus more resources on determining what the complicated part of the phone call means instead of wasting resources on the simpler parts of the phone call.

Another practical application is agentic reasoning. For example, a person queries an artificial intelligence (AI) agent to book a flight. The agent will parse the request to book the flight so that the easier tasks (non-decomposed) go to a simpler large language model (LLM) while the harder tasks (decomposed) go to a more complicated LLM. This practical application leads to better resource allocation.

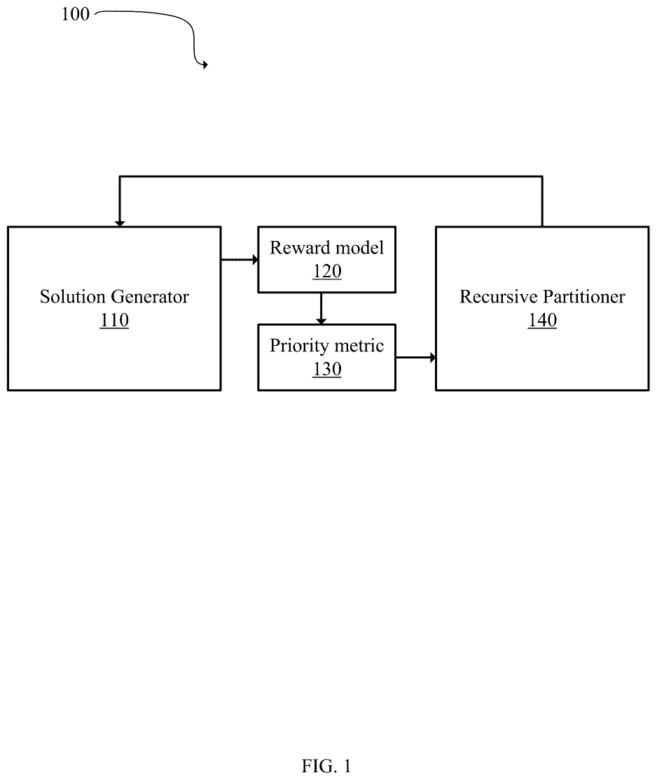

Referring now in detail to the figures in which like numerals represent the same or similar elements and initially to FIG. 1, a high-level system/method 100 for decomposition is illustratively depicted in accordance with one embodiment of the present invention. The system and method 100 can include a solution generator 110, a reward model 120, a priority metric 130, and a recursive partitioner 140. The solution generator 110 can generate solutions until there is sufficient solutions for the reward model or a budget threshold is met. For example, the solution generator 110 may stop generating solutions because the solution generator 110 has hit the allocated budget. The reward model 120 can be used to select a step from the completed solutions. Once a step is selected, the reward model 120 is used to generate the priority metric 130. The priority metric 130 determines the partitioning in the recursive partitioner 140. The recursive partitioner 140 partitions the selected step and uses the priority metric 130 to determine which partitioned segment of the selected step is more difficult. For example, a priority metric might be lower for one partitioned segment over another, indicating that the partitioned segment is more difficult.

The recursive partitioner 140 can send the more difficult partitioned segment to the solution generator 110 to start the process again with the more difficult partitioned segment being the selected step. This process can repeat recursively until a precision threshold is met or a splitting threshold is met.

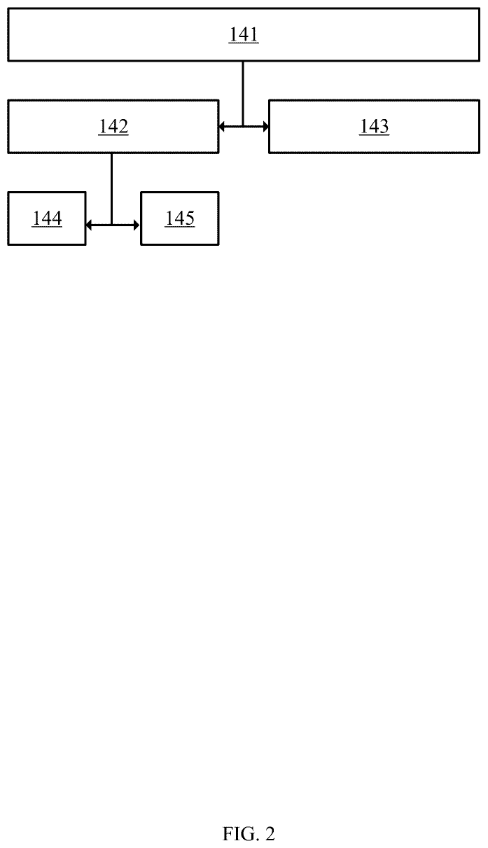

Referring to FIG. 2, a first step 141 is partitioned into first step segments 142 and 143. Each first step segment 142, 143 is assigned a value by the priority metric. The value can refer to how difficult each segment is to process. In this example, first step segment 142 has a lower priority value which inversely means higher difficulty. Thus, first step segment 142 is partitioned into second step segments 144 and 145.

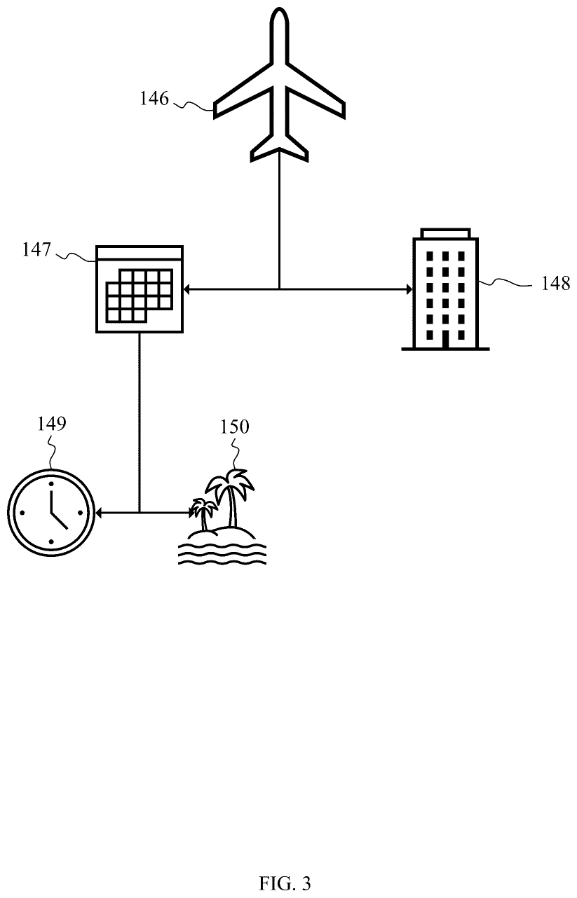

Referring to FIG. 3, borrowing the example of booking a flight ticket, the first step 146 represents booking a flight. Then the booking flight request 146 is partitioned into two first step segments 147 and 148. First step segment 147 represents booking the flight on a specific date and first step segment 148 represents deciding which flight company to use. Since first step segment 147 is more difficult because of its lower priority score, the first step segment 147 gets partitioned into second step segments 149 and 150. Continuing with this example, second step segment 149 represents what time during the day to book the flight and second step segment 150 represents which destination to pick.

Referring back to FIG. 1, the system and method 100 can be viewed as a recursive binary decomposition approach that iteratively breaks down complex solutions into smaller, more manageable steps. Give a problem prompt x, the algorithm outputs a decomposition of a solution, Y={y₁, y₂, . . . , yₖ}, such that the concatenation y_{1 . . . k}=y₁·y₂· . . . ·yₖ forms a complete solution to x. The system and method 100 can be viewed as operating in two key stages.

The first key stage can be viewed as solution sampling. Starting from x and y₀=Ø, the solution generator 110 generates complete solutions y~π(·|x·y₀) using a policy π. The best solution, y*, is selected based on a reward model R.

The second key can be viewed as recursive partitioning. The recursive partitioner 140 partitions the selected solution y* into two segments,

$${y}^{*} = {y}_{1}^{*} \cdot {y}_{2}^{*} ,$$

based on a predefined partition fraction α, where

$$\vert {y}_{1}^{*} \vert \approx α \vert {y}^{*} \vert .$$

For each part, a priority metric h is estimated:

$$\hat{h} ( {y}_{1}^{*} \vert x ) and \hat{h} ( {y}_{2}^{*} \vert x \cdot {y}_{1}^{*} ) ,$$

usually through rollouts of the step using π. The part with a lower priority is further partitioned.

If

$$\hat{h} ( {y}_{1}^{*} \vert x ) \geq \hat{h} ( {y}_{2}^{*} \vert x \cdot {y}_{1}^{*} ) ,$$

additional samples are sampled for

$${y}_{2}^{*} ,$$

with the process repeating on the new best solution

$${y}_{2}^{*} .$$

Conversely, if

$$\hat{h} ( {y}_{1}^{*} \vert x ) \leq \hat{h} ( {y}_{2}^{*} \vert x \cdot {y}_{1}^{*} ) ,$$

the first segment

$${y}_{1}^{*}$$

is further partitioned. The first step corresponds to the α fraction of

$${y}_{1}^{′ *} ,$$

with the remaining part of the full solution forming the second step.

The priority metric h 130 can be the central heuristic for determining which part of the solution to prioritize. The priority metric 130 can evaluate the “difficulty” or importance of a step y′ given the current state x·y. The priority metric can be estimated through rollouts of the policy π. Specifically, h(y′|x·y) is computed by sampling potential continuations and evaluating their outcomes.

The estimation of h and the generation of new solution samples can be performed simultaneously, as both can involve rollout-based computations.

Because embodiments of the present invention break down difficult steps into smaller steps, the embodiments are particularly effective for inference scaling, where computational resources are limited and need to be allocated judiciously.

Another advantage of the embodiments is the ability to dynamically prioritize challenging steps, ensuring a higher likelihood of finding optimal solutions while minimizing compute waste on trivial steps. By iteratively refining difficult steps with lower priority metrics, embodiments of the present invention adaptively allocate more computational resources to challenging parts of the solution while spending less on simpler steps. This dynamic allocation optimizes the use of inference compute time.

In an embodiment, the priority metric 130 can be a Q-value based priority. Let

$${y}_{012}^{*} = {y}_{0}^{*} \cdot {y}_{12}^{*} = {y}_{0}^{*} \cdot {y}_{1}^{*} \cdot {y}_{2}^{*}$$

denote the optimal solution, where one would like to partition the latter step

$${y}_{12}^{*} .$$

In a Q-value based partition, one compares the average Q-value of the first step

$${y}_{1}^{*}$$

with that of the second step

$${y}_{2}^{*} .$$

Continuing with this embodiment, the priority metric 130 can be defined as

$${h}_{Q} ( {y}^{*} \vert x \cdot y ) = {𝔼}_{{y}^{′} \sim π ( \cdot \vert x \cdot y \vert ) , \vert {y}^{′} \vert = \vert {y}^{*} \vert} [ {Q}^{π} ( {y}^{′} \vert x \cdot y ) ]$$

To estimate the average Q-value for the second step,

$${h}_{Q} ( {y}_{2}^{*} \vert x \cdot {y}_{0}^{*} ) ,$$

the solution generator 110 generates samples

$${y}_{2} ∼ π ( \cdot \vert x \cdot {y}_{01}^{*} ) ,$$

perform rollouts y₂₊ to completion, calculate the outcome rewards, and take the mean. For the first step, recall that the solution generator 110 already generated rollout samples for y₁₂ in the previous portioning. The mean of these samples actually serves as an unbiased estimator for

$${h}_{Q} ( {y}_{1}^{*} , x \cdot {y}_{0}^{*} ) :$$

$${h}_{Q} ( {y}_{1}^{*} , x \cdot {y}_{0}^{*} ) = 𝔼 [ {\hat{h}}_{Q} ( {y}_{12}^{*} , x \cdot {y}_{0}^{*} ) ]$$

where [symbol] means expectation.

This approach eliminates the need to re-sample the first step for metric estimation. Furthermore, since there is already generated full rollouts for y₂, the priority metric can simply select the best rollout

$${y}_{2 +}^{*}$$

as the next optimal step to partition. By combining the rollouts for estimation and search, computer efficiency is increased.

The intuition behind a Q-value based split is that steps with lower Q-values are more critical to refine and optimize further.

In an embodiment, the priority metric 130 can use Maximum Advantage Based Priority. The advantage-based priority metric is defined as:

$${h}_{A} ( {y}^{*} \vert x \cdot y ) = {max}_{{y}^{′} , \vert {y}^{′} \vert = \vert {y}^{*} \vert} [ {Q}^{π} ( {y}^{′} \vert x \cdot y ) ] - {h}_{Q} ( {y}^{*} \vert x \cdot y ) .$$

This metric quantifies the maximum advantage achievable for a given step, measuring how much better it can perform compared to the average sample. The intuition is that steps with lower advantage have greater potential for improvement, warranting more granular decomposition and search. Conversely, steps with higher maximum advantage are likely already optimal and require less refinement. The maximum advantage can be estimated through rollouts, same as how the ĥ_{Q} was estimated.

In an embodiment, the priority metric 130 uses Z-score Based Priority. Ideally, the priority metric 130 would like to allocate more compute (through decomposition) to steps that have a higher potential for improvement. The priority metric 130 can estimate the potential through estimating the probability that the solution generator 110 sample a better step based on the existing samples. If the priority metric 130 assumes that the samples follow a normal distribution, then, given mean μ and standard deviation σᵣ the probability of sampling better than the best sample

$${r}^{*} is 1 - CDF ( \frac{{r}^{*} - {μ}_{r}}{{σ}_{r}} ) = 1 - CDF ( {z}^{*} ) ,$$

where z* is the z-score. CDF stands for cumulative distribution function and r is the reward value for rollout. Recall that r*−μᵣ is how the priority metric 130 defined the advantage metric. Since the CDF is monotonic, for comparison purposes, the priority metric 130 just needs to compare the z-score of two steps. The Z-score priority metric can be defined as follows:

$${h}_{Z} ( {y}^{*} \vert x \cdot y ) = \frac{{h}_{A} ( {y}^{*} \vert x \cdot y )}{Std ( R ( {y}^{′} \vert x \cdot y ) )}$$

where Std stands for standard deviation

Hence, the z-score metric can be interpreted as standard deviation scaled version of the advantage metric.

In summary, the Q-value and advantage-based metrics provide complementary perspectives for prioritizing steps in the framework, enabling efficient and targeted optimization of the solution space.

In an embodiment, the embodiment can be used to enhance Monte Carlo Tree Search (MCTS) and other inference scaling and search methods. Recall that the recursive partitioner 140 greedily partitions the best solution step y*. Instead of greedily partitioning the best step, the recursive partitioner 140 can partition the top k best steps instead and select which step to partition using the upper confidence tree (UCT) formula. One major problem with using step-by-step MCTS in language settings where the action space is large is that it is difficult to determine the step size.

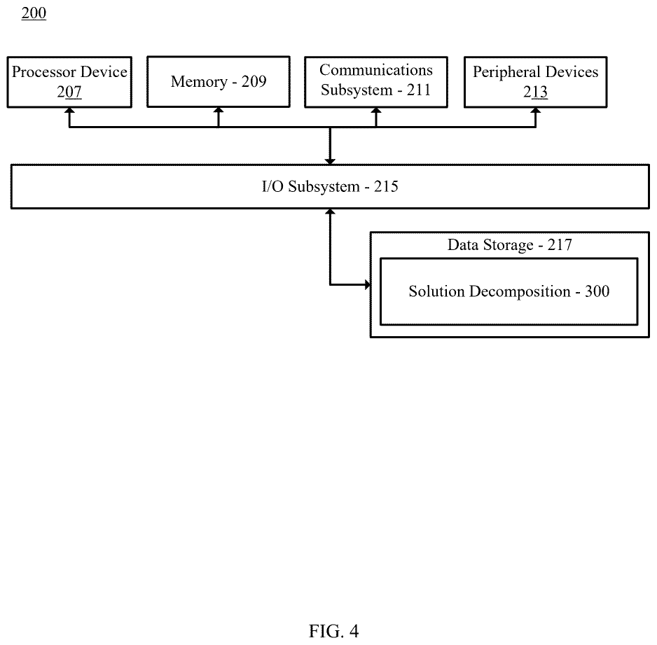

Referring now to FIG. 4, a block diagram of a computer system for solution decomposition, in accordance with an embodiment of the present invention.

The computing device 200 illustratively includes the processor device 207, the input/output (I/O) subsystem 215, the memory 209, the data storage device 217, and the communications subsystem 211, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 209, or portions thereof, may be incorporated in the processor device 207 in some embodiments.

The processor device 207 may be embodied as any type of processor capable of performing the functions described herein. The processor device 207 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 209 may be embodied as any type of volatile or non-volatile memory or data storage capable of performing the functions described herein. In operation, the memory 209 may store various data and software employed during operation of the computing device 200, such as operating systems, applications, programs, libraries, and drivers. The memory 209 is communicatively coupled to the processor device 207 via the I/O subsystem 215, which may be embodied as circuitry and/or components to facilitate input/output operations with the processor device 207, the memory 209, and other components of the computing device 200. For example, the I/O subsystem 215 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 215 may form a portion of a system-on-a-chip (SOC) and be incorporated, along with the processor device 207, the memory 209, and other components of the computing device 200, on a single integrated circuit chip.

The data storage device 217 may be embodied as any type of device or devices configured for short-term or long-term storage of data such as, for example, memory devices and circuits, memory cards, hard disk drives, solid state drives, or other data storage devices. The data storage device 217 can store program code for solution decomposition 300. Any or all of these program code blocks may be included in a given computing system.

The communications subsystem 211 of the computing device 200 may be embodied as any network interface controller or other communication circuit, device, or collection thereof, capable of enabling communications between the computing device 200 and other remote devices over a network. The communications subsystem 211 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 213. The peripheral devices 213 may include any number of additional input/output devices, interface devices, and/or other peripheral devices. For example, in some embodiments, the peripheral devices 213 may include a display, touch screen, graphics circuitry, keyboard, mouse, speaker system, microphone, network interface, and/or other input/output devices, interface devices, global positioning system (GPS), camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

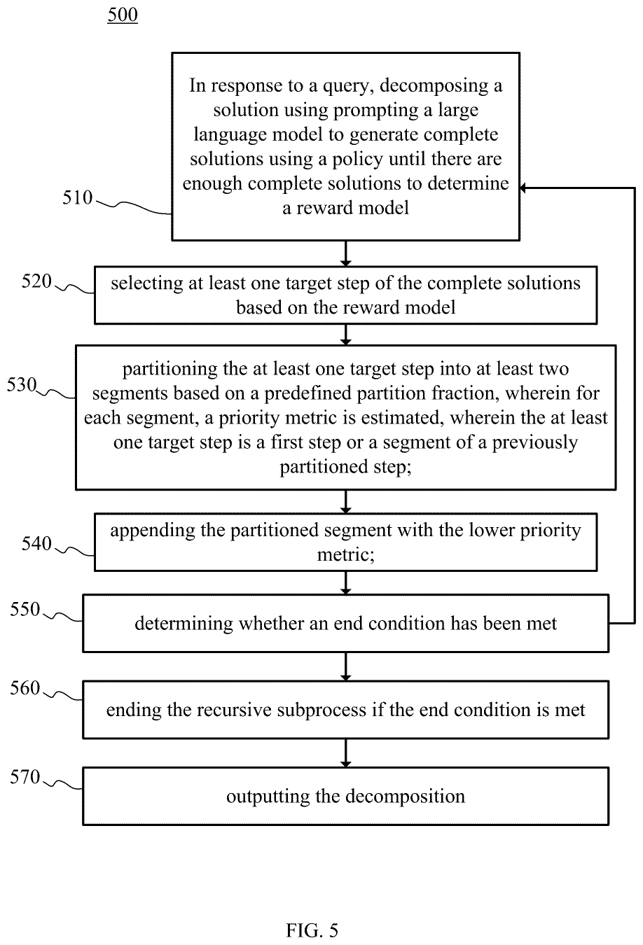

Referring now to FIG. 5, a flow diagram 500 of a high-level overview of solution decomposition, in accordance with an embodiment of the present invention.

In block 510, in response to a query, decomposing a solution using complete solutions are generated using a policy until there are enough complete solutions to determine a reward model.

In block 520, at least one target step of the complete solutions is selected based on the reward model.

In an embodiment, more than one target step is selected.

In block 530, at least one target step is partitioned into at least two segments based on a predefined partition fraction. For each segment, a priority metric is estimated. The priority metric can be representative how difficult a segment is to compute. The target step can be a first step or a previously partitioned step.

In an embodiment, the priority metric can be a Q-value Based Priority.

In an embodiment, the priority metric can be Maximum Advantage Based Priority.

In an embodiment, the priority metric can be Z-score Based Priority.

Continuing with the embodiment where more than one target step is obtained, the priority metric can be the upper confidence tree formula.

In block 540, the partitioned segment with a lower priority metric is appended.

In block 550, there is a determination whether the end condition has been met. In an embodiment, the end condition is a splitting threshold. In an embodiment, the end condition is a precision threshold. In an embodiment, the end condition is that the new z-score is higher than the previous z-score.

In block 560, the recursive subprocess is ended if the end condition is met.

In block 570, a decomposition is output.

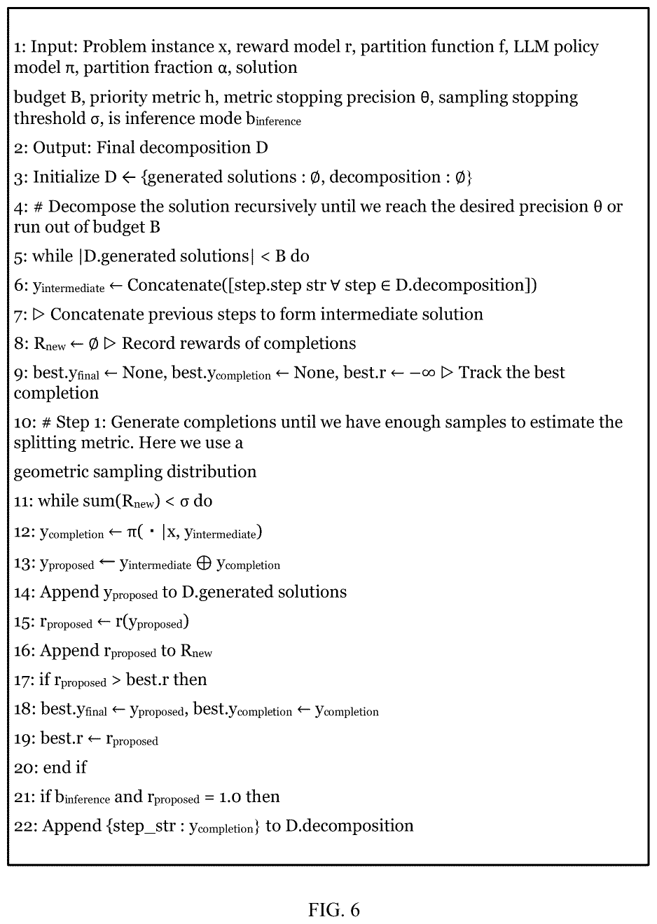

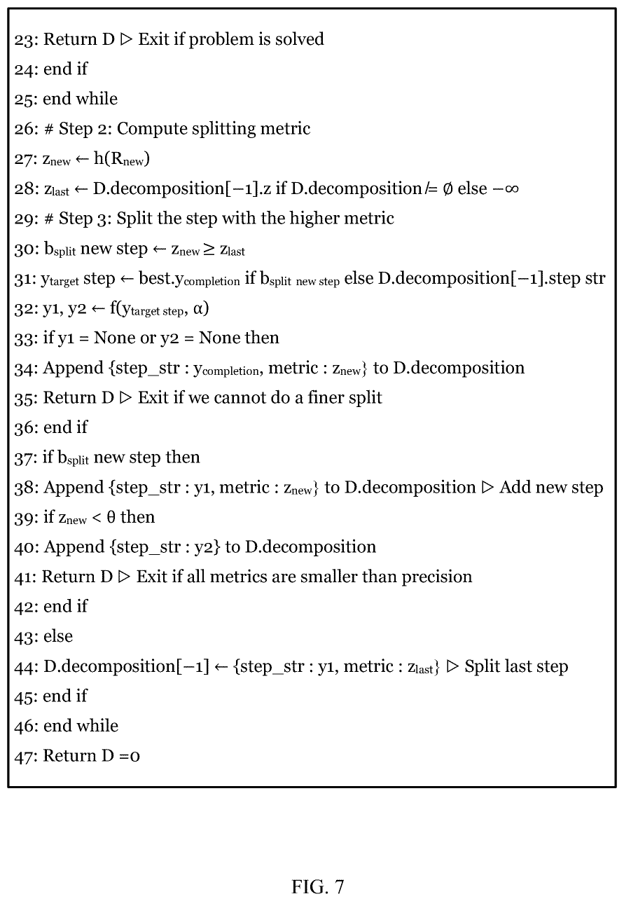

FIG. 6 and FIG. 7 show a pseudocode program illustrating an embodiment of the present invention. The pseudocode involves inputs including: problem instance x, reward model r, partition function f, LLM policy model π, partition fraction α, solution

budget B, priority metric h, metric stopping precision θ, sampling stopping threshold σ, and is inference mode b_{inference}. The final output is final decomposition D. The pseudocode first initializes decomposition d. Then the pseudocode decomposes the solution recursively until the pseudocode reaches the desired precision or runs out of budget. The first step of the recursive subprocess is to generate completions until there are enough samples to estimate a splitting metric. In this pseudocode, a geometric sampling distribution is sued. After there are enough samples, the pseudocode computes a splitting metric. After computing the splitting metric, the pseudocode splits the step with the higher metric. The end conditions for the recursive subprocess include: that a finer split cannot be done, the budget is used, all metrics are smaller than precision, and if the problem is solved.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for solution decomposition, the method comprising:
in response to a query, decomposing a solution using a recursive subprocess including:
prompting a first large language model (LLM) to generate complete solutions using a policy until there are enough complete solutions to determine a reward model;
selecting at least one target step of the complete solutions based on the reward model;
partitioning the at least one target step into at least two segments based on a predefined partition fraction, wherein for each segment, a priority metric is estimated, wherein the at least one target step is a first step or a segment of a previously partitioned step;
appending the partitioned segment with a lower priority metric;
determining whether an end condition has been met; and
ending the recursive subprocess if the end condition is met; and
outputting a decomposition.

2. The method of claim 1, wherein the priority metric is estimated through rollouts of the policy.

3. The method of claim 1, wherein the priority metric is estimated using Q-Value Based Priority.

4. The method of claim 1, wherein the priority metric is estimated using Maximum Advantage Based Priority.

5. The method of claim 1, wherein the priority metric is estimated using Z-score Based Priority.

6. The method of claim 1, wherein more than one target step is selected.

7. The method of claim 6, wherein the priority metric is an upper confidence tree formula.

8. The method of claim 1, wherein the end condition is a splitting threshold.

9. The method of claim 1, wherein the end condition is that the estimated priority metric is below a precision threshold.

10. The method of claim 1, further comprising:
allocating the decomposition to a second LLM;
allocating the non-decomposed portions to a third LLM, wherein the second LLM is more computationally complex than the third LLM.

11. A system, comprising:
a memory device;
one or more processor devices operatively coupled with the memory device to perform operations, the operations including:
in response to a query, decompose a solution using a recursive subprocess including:
prompt a large language model to generate complete solutions using a policy until there are enough complete solutions to determine a reward model;
select at least one target step of the complete solutions based on the reward model;
partition the at least one target step into at least two segments based on a predefined partition fraction, wherein for each segment, a priority metric is estimated, wherein the at least one target step is a first step or a segment of a previously partitioned step;
append the partitioned segment with a lower priority metric;
determine whether an end condition has been met; and
end the recursive subprocess if the end condition is met; and
output a decomposition.

12. The system of claim 11, wherein the priority metric is estimated through rollouts of the policy.

13. The system of claim 11, wherein the priority metric is estimated using Q-Value Based Priority.

14. The system of claim 11, wherein the priority metric is estimated using Maximum Advantage Based Priority.

15. The system of claim 11, wherein the priority metric is estimated using Z-score Based Priority.

16. The system of claim 11, wherein the end condition is a splitting threshold.

17. The system of claim 11, wherein the end condition is that the estimated priority metric is below a precision threshold.

18. A non-transitory computer program product comprising a computer-readable storage medium including a program code, wherein the program code when executed on a computer causes the computer to perform:
in response to a query, decompose a solution a recursive subprocess including:
prompt a large language model to generate complete solutions using a policy until there are enough complete solutions to determine a reward model;
select at least one target step of the complete solutions based on the reward model;
partition the at least one target step into at least two segments based on a predefined partition fraction, wherein for each segment, a priority metric is estimated, wherein the at least one target step is a first step or a segment of a previously partitioned step;
append the partitioned segment with a lower priority metric;
determine whether an end condition has been met; and
end the recursive subprocess if the end condition is met; and
output a decomposition.

19. The computer program product of claim 18, wherein the end condition is a splitting threshold.

20. The computer program product of claim 18, wherein the end condition is that the estimated priority metric is below a precision threshold.
